(19) United States
(12) Patent Application Publication
(10) Pub. No.: US 2014/0365317 A1
(43) Pub. Date: Dec. 11, 2014

(54) SYSTEM AND METHOD FOR IMPROVED ADVERTISEMENT REASSIGNMENT AND BID PRICING

(71) Applicant: Gagan Goel, New York, NY (US)

(72) Inventor: Gagan Goel, New York, NY (US)

(73) Assignee: Google Inc., Mountain View, CA (US)

(21) Appl. No.: 13/559,517

(22) Filed: Jul. 26, 2012

(51) Int. Cl. G06Q 30/02; G06Q 30/08

(52) U.S. Cl. 705/14.71

(57) ABSTRACT

This specification describes technologies relating to content presentation. One aspect of the subject matter described herein can be embodied in methods that include: selecting an auction including a first bid from a first advertiser that is associated with a first advertisement, and a second bid from a second advertiser that is associated with a second advertisement, computing respective effective bids that reflecting a product of the respective bids and a respective randomly selected values, comparing the respective effective bids to identify a winning bid, based on an identification of the second effective bid as the winning bid, charging the second advertiser a final auction price reflecting the first effective bid divided by the second value, and charging the first advertiser a baseline price, and providing, based on the winning bid, the first advertisement and/or the second advertisement. Other embodiments include corresponding systems, apparatus, and computer program products.

### BACKGROUND

The present disclosure relates to content presentation.

Advertisers provide content such as advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a webpage or a mobile application, as an impression. An advertising system can include an ad in a webpage, for example, in response to one or more keywords in a user search query input to a search engine. If a user selects the presented ad (e.g., by “clicking” the ad), the user is generally taken to another location associated with the ad, for example, to another, particular web page.

Content such as advertisements can be allocated through an auction process. For example, advertisers can provide bids specifying amounts that the advertisers are respectively willing to pay for presentation of their advertisements. In turn, an auction can be performed and advertisement slots (e.g., locations on a web page or within a mobile application) can be allocated to advertisers according to their bids. When one advertisement slot is being allocated in the auction, the advertisement slot can be allocated to the advertiser that provided the highest bid or a highest auction score (e.g., a score that is computed as a function of a bid and/or an advertisement quality measure). When multiple advertisement slots are allocated in a single auction, the advertisement slots can be allocated to a set of bidders that provided the highest bids or have the highest auction scores.

### SUMMARY

This specification describes technologies relating to content presentation.

In general, one aspect of the subject matter described in this specification can be embodied in methods for providing advertisements. The method includes the actions of: selecting an auction, the auction including at least (a) a first bid from a first advertiser, the first bid being associated with a first advertisement, and (b) a second bid from a second advertiser, the second bid being associated with a second advertisement, computing (a) a first effective bid, the first effective bid including a product of the first bid and a first value and (b) a second effective bid, the second effective bid including a product of the second bid and a second value, comparing the first effective bid and the second effective bid to identify a winning bid, based on an identification of the second effective bid as the winning bid, charging the second advertiser a final auction price that includes the first effective bid divided by the second value, and charging the first advertiser a baseline price, and providing, based on the winning bid, the first advertisement and/or the second advertisement.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a diagram of an example content presentation system.

FIG. 2 is a block diagram of an example system for providing advertisements.

FIG. 3 is a flow chart of an example process for providing advertisements.

FIG. 4A is an exemplary screenshot showing assignments of various advertisements within a webpage.

FIG. 4B is an exemplary screenshot showing reassignments of various advertisements within a webpage.

FIG. 5 shows an example of a computing device and a mobile computing device that can be used in connection with computer-implemented methods and systems described in the present specification.

Like reference symbols in the various drawings indicate like elements.

### DETAILED DESCRIPTION

By way of overview and introduction, it can be appreciated that auctions can be conducted between various advertisers for the right to provide advertisements within one or more ad slots, such as ad slots that are presented to users who submit queries to a search engine. In certain implementations, such auctions are conducted based on maximum bids provided by advertisers for a particular keyword or keywords (which correspond to the queries submitted by a user to the search engine). Upon receiving the query from the user, the auction is conducted, and, in most cases, various advertisements are positioned in the ad slots in accordance with the maximum bids provided by the advertisers. Thus, an advertiser providing a higher maximum bid (e.g., $0.50 per click) will generally be assigned a higher or more preferable position than an advertiser providing a lower maximum bid (e.g., $0.25 per click). It should also be noted that such auctions can be conducted using various pricing methods, such as a generalized second-price (GSP) auction, as is known to those of ordinary skill in the art.

It can be further appreciated that while conventional auction approaches assign advertisements to relative positions based on the respective maximum bids associated with each advertisement, such an arrangement may be sub-optimal. For example, despite the fact that one advertisement may have a higher maximum bid than another (and would thus typically be assigned to a higher or more preferable position), the advertisement having the lower bid might actually be a higher quality advertisement, and might have the potential—if positioned in the higher position—to generate more advertising revenue, per impression (e.g., on account of a higher click-through rate) than the advertisement with the higher maximum bid. Additionally, an advertisement associated with a relatively higher bid might not experience a significant decrease in traffic/interest if assigned to a lower position, and, if this is the case, the advertiser receives little additional value by providing a relatively high bid for such an advertisement (being that the same or similar results might be achieved with a lower bid amount).

It should also be noted that such determinations (e.g., whether various advertisements can be more effectively arranged based on factors other than only the relative size of their respective bids) can only be projected or predicted with a limited degree of accuracy. As such, various techniques can be implemented whereby a relatively small number/percentage of the total number of auctions that are conducted can be dedicated to the exploration of the alternative positioning of the various advertisements in an auction. For example, in certain implementations, the positions of two advertisements can be swapped (that is, exchanged for one another or otherwise reassigned), and the results of such a swap can be observed (e.g., the resulting click-through rate, etc.) thereby providing additional insight towards a more optimal arrangement of advertisements.

As described herein, the manner in which such advertisements are swapped can be further improved by accounting for the inherent competition that exists between two ads in an auction, and their respective maximum bids (as opposed to simply swapping their respective positions indiscriminately). For example, effective bids can be computed for each advertisement in an auction, the effective bids reflecting an original bid amount multiplied by a randomly selected value. Such effective bids can be compared with one another, and such advertisement swaps can be conducted based on the comparison of the effective bids. In doing so, in auctions where one bid is significantly lower than another, it will be less likely that the bids in such an auction will be swapped.

Moreover, upon swapping the positions of two advertisements based on their respective effective bids, the respective prices charged to each respective advertiser can be computed in a manner that accounts for the competition that exists in the auction between the swapped advertisements. For example, an advertiser whose advertisement was swapped to a higher position can be charged a final auction price that corresponds to the effective bid of the competing advertisement divided by the random value that was multiplied against the bid of the advertisement that was swapped to the higher position. As described in greater detail herein, such an implementation results in greater overall advertising revenue than that achieved using a conventional GSP approach. In doing so, the revenue generated by such experimental or exploratory auctions can be maximized or improved beyond that achieved using conventional auction pricing approaches.

While reference will be made below to advertising systems and processes, other forms of content including other forms of sponsored content can be managed and presented in accordance with the description below.

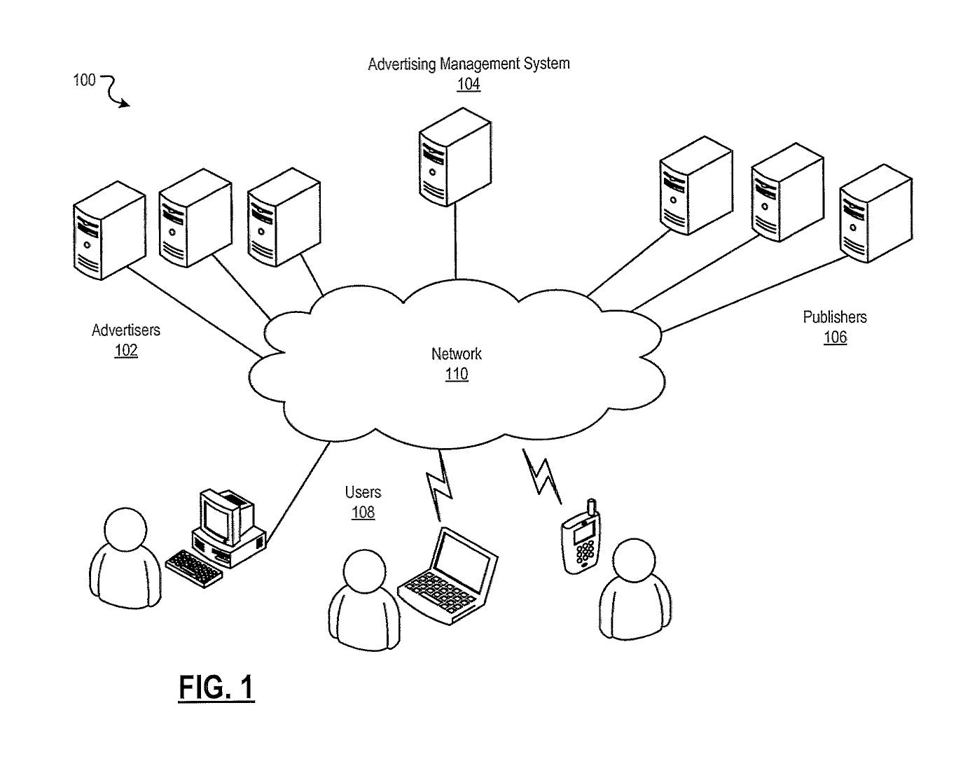

FIG. 1 is a block diagram showing an example content presentation system 100. In some implementations, one or more advertisers 102 can directly, or indirectly, enter, maintain, and log ad information in an advertising management system 104. Though reference is made to advertising, other forms of content, including other forms of sponsored content, can be delivered by the system 100. The ads can be in the form of graphical ads, such as banner ads, text-only ads, image ads, audio ads, video ads, ads combining one or more of any of such components, etc. The ads can also include embedded information, such as links, meta-information, and/or machine executable instructions.

One or more publishers 106 can submit requests for ads to the system 104. The system 104 responds by sending ads to the requesting publisher 106 for placement on, or association with, one or more of the publisher's content items (e.g., web properties such as web pages). It should also be understood that in certain implementations, ads can be provided in a substantially similar manner in television and radio advertising slots, and/or print media space.

Other entities, such as users 108 and the advertisers 102, can provide usage information to the system 104, such as, for example, whether or not a conversion (e.g., a purchase or other interaction including, for example, a request for driving directions to a location associated with an ad, navigating to the location associated with the ad, or walking to the location associated with the ad) or a click-through related to an ad (e.g., a user has selected an ad) has occurred. This usage information can include measured or observed user behavior related to ads that have been served. In some cases, a user may enable and/or disable the recording or observation of such usage information. The system 104 can perform financial transactions, for example, crediting the publishers 106 and charging the advertisers 102 based on the usage information.

A network 110, such as a local area network (LAN), wide area network (WAN), the Internet, one or more telephony networks or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for content such as ads to a content server such as an advertisement server in the system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser can combine the requested content with one or more of the ads provided by the system 104. The combined content and ads can be sent/rendered to the users 108 that requested the content for presentation in a viewer (e.g., a browser or other content display system). The content server can transmit information about the ads back to the content server, including information describing how, when, and/or where the ads are to be rendered (e.g., in HTML or JavaScript™)

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and can be grouped into a predetermined number of (e.g., ten) search results.

The search service can submit a request for ads to the system 104. The request can include a number of ads desired. This number can depend on the search results, the amount of screen or page space occupied by the search results, the size and shape of the ads, and/or a variety of other factors. In some implementations, the number of desired ads will be from one to ten, or from three to five. The request for ads can also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

In some implementations, the content management system 104 includes an auction process to select ads from the advertisers 102. For example, the advertisers 102 can be permitted to select, or bid, an amount the advertisers are willing to pay for each presentation of or interaction with (e.g., click of) an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 can submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the user 108, e.g., by the execution of a particular script when the publisher's web page is loading on a client device.

In some alternative implementations, an ad push model is used to provide ads from advertisers 102. In an ad push model, ads can be pushed to idle screens (e.g., of a mobile devices or particular applications) based on particular criteria (e.g., the user's location).

In another example publisher 106 is a mobile application developer. A mobile application is an application specifically designed for operation on a mobile device (e.g., a smart phone).

The mobile application can also include ads positioned within the content of the mobile application. Similar to publishers 106, the ads can be received from the system 104 for placement in the mobile application when accessed by a user (e.g., when a particular page of a mobile application is loaded on the mobile device).

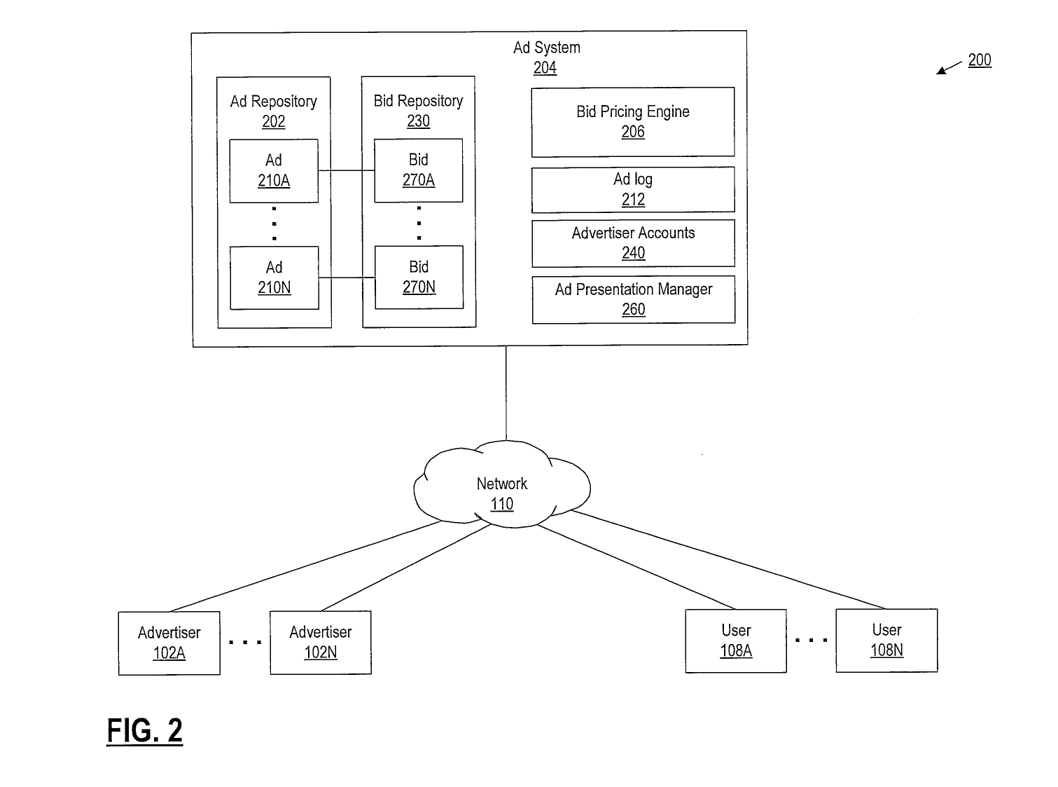

FIG. 2 is a block diagram of an example system 200 for providing advertisements. In the system 200, an advertiser 102A-102N (referred to collectively as advertisers 102) can submit one or more ads 210A-210N (also known as “creatives”) (referred to collectively as ads 210) to an ad system 204, and such ads 210 are stored in an ad repository 202. Each ad (e.g., ad 210A) includes one or more words, phrases, web links, and/or any other such element and/or component (e.g., images, video, audio, etc.) that are provided to one or more users 108 (e.g., banner ads, text-only ads, image ads, audio ads, video ads, etc.). In certain implementations, one or more keywords (not shown) are associated with one or more creatives in order to enable the identification and selection of pertinent ads for display to a user based on one or more search queries received from the user. It should also be noted that although ads 210 are described herein as referring to individual ads, in certain implementations ads 210 can refer to groups of ads, such as ad groups, campaigns, and/or categories.

Ad system 204 can also include an ad presentation manager 260. The ad presentation manager 260 can identify ads in the ad repository 202 to present to a user 108, for example based on various criteria such as keywords in a search query, web page content, context, location, ad financials (e.g., cost per impression). For example, ad presentation manager 260 can identify one or more ads 210 associated with one or more keywords that are similar and/or identical to the search query provided by the user, and such creatives can be provided to the user in any number of ad formats. It should be understood that in some implementations, the ad system 204 can interact with a search system, for example presenting ads alongside search results. In some implementations, the ad system 204 can interact with content publishers, for example, providing ads to publishers or users for presentation along with web content, e-mail, or other content.

Ad system 204 can also include one or more ad logs 212. Ad log 212 can track and store one or more performance metrics that reflect the performance or success of a particular ad. For example, for a given ad, ad log 212 can track the ‘click through rate,’ reflecting the percentage of users presented with a creative that click on or otherwise select the presented content, though it should be understood that any number of other performance metrics can be similarly tracked (e.g., conversion rate), as is known to those of ordinary skill in the art.

Ad system 204 can also include a bid repository 230 that stores one or more bids 270A-270N (referred to collectively as bids 270). In certain implementations, such bids correspond to a particular and/or maximum monetary amount provided by an advertiser 102 for a particular instance or occurrence (or a defined amount of instances/occurrences) within the context of an advertising auction. Moreover, in certain implementations, each bid 170 is associated with a respective advertisement 210, thus reflecting a particular/maximum amount that an advertiser 102 is willing to pay for display of the associated ad. For example, advertiser 102A can provide a maximum cost-per-click (CPC) bid 270A (e.g., up to $0.25 per click) in an advertising auction for the display of ad 210A. It should also be understood that bids 270 can reflect any number of monetization formats, including but not limited to cost-per-click and/or cost-per-impression.

Additionally, ad system 204 can include a bid pricing engine 206. The bid pricing engine 206 can compute bid amounts for selected auctions, such as in the manner described herein. It should be understood that in some implementations bid pricing engine 206 can include one or more processors configured by code to implement the functionality of the bid pricing engine that is being described.

Ad system 204 can also include one or more advertiser accounts 240. Each individual advertiser account (not shown) corresponds to advertising funds associated with a particular advertiser 102. Funds are deducted from such accounts upon the successful serving of one or more ads on behalf of a particular advertiser, such as in the manner described in detail herein.

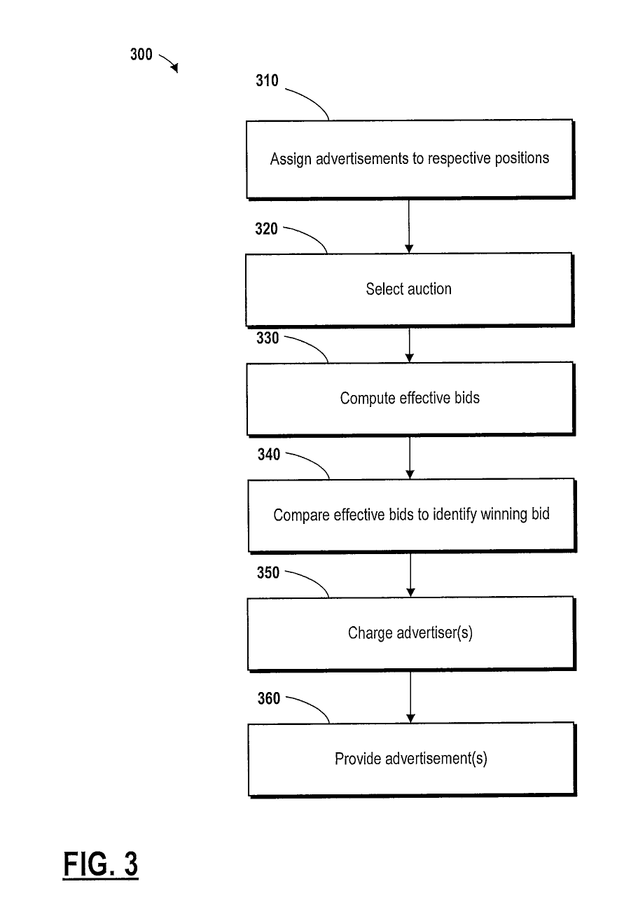

FIG. 3 is a flowchart of an example method 300 for providing advertisements. In some implementations, the method 300 can be performed by a processor executing instructions in a computer-readable storage medium. For example, the method 300 can be performed by the ad system 204 of FIG. 2.

One or more advertisements are assigned to respective positions (310). For example, a first advertisement can be assigned to a first position and a second advertisement can be assigned to a second position. It should be understood that in certain implementations, advertisements can be assigned to respective positions based on the respective auction bids that are associated with each advertisement. For example, in an auction where a first bid is $0.50 per click (reflecting the fact that the advertiser is willing to pay up to that amount for a user clicking on a particular advertisement), while a second bid is $0.25 per click, the advertisement being associated with the higher bid (in this example, $0.50 per click) will be assigned to a higher or more preferable position (e.g., a first position) relative to the position of the lower bid (which can be assigned to a lower or less preferable position, or not assigned to a position at all). At this juncture, it should be understood that in most advertising formats and settings, relatively higher positions (that is, closer to the top or beginning of a page/screen) generate, on average, more interest from users, and are thus more desirable (and thus valuable) to advertisers. However, it should be understood that in certain settings, other positions (i.e., those that are not necessarily at the top of a page/screen) can be more preferable (e.g., a position that is in close proximity to a particular content item).

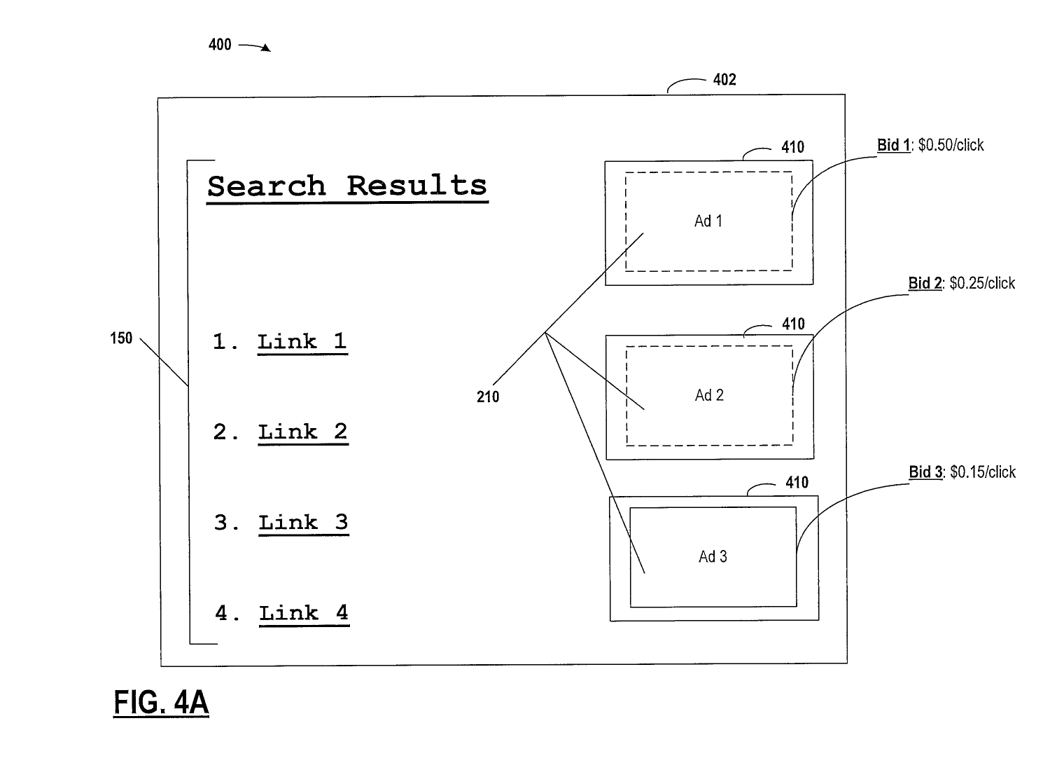

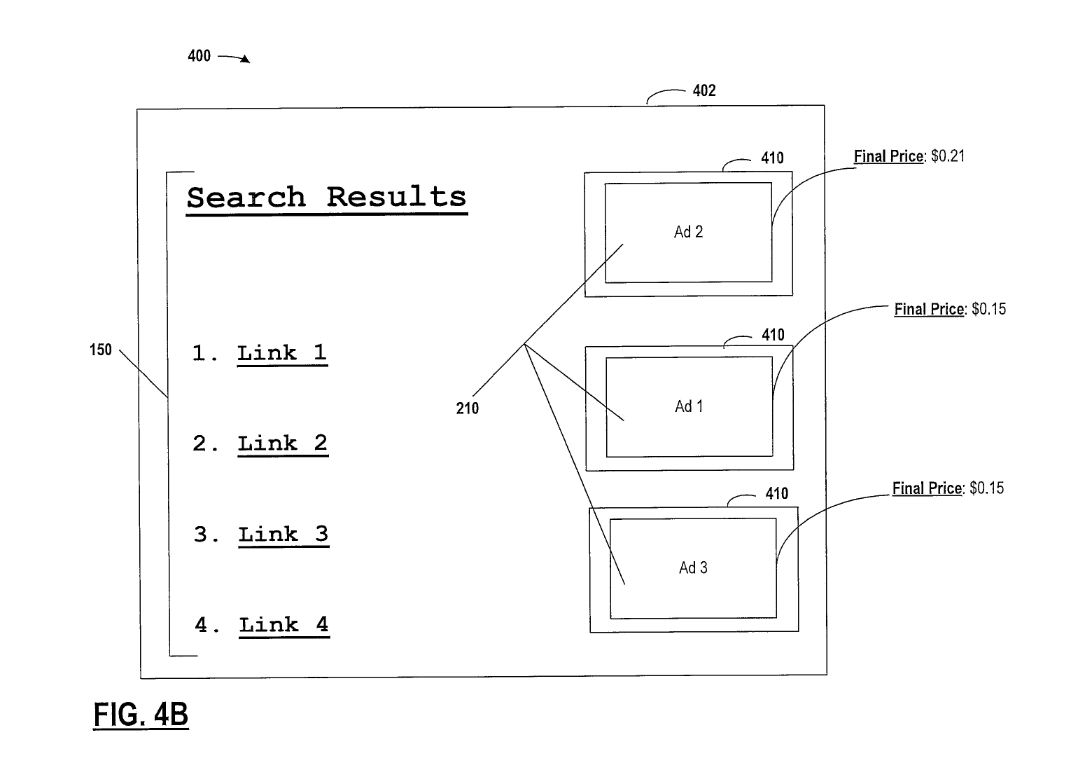

By way of further illustration, FIG. 4A depicts an exemplary screenshot 400, reflecting an exemplary webpage 402 provided to user 108. Webpage 402 includes website content 150 (e.g., HTML code operative to render text, embedded media, hyperlinks, etc. in a web browser), such as a list of search results provided in response to a user query, and various positions 410 (also known as ad slots) situated in specific locations within the webpage 402, such as along the right side of the webpage as shown in FIG. 4A. Accordingly, it can be appreciated that a first advertisement 210 (e.g., ‘Ad 1,’ associated with a bid of $0.50) can be assigned to a first position (e.g., the top or first position, as shown in FIG. 4A), while a second advertisement 210 (e.g., ‘Ad 2,’ associated with a bid of $0.25) can be assigned to a second position. It should also be noted that ‘Ad 1’ and ‘Ad 2’ are indicated with dashed lines to reflect that their respective positions are merely representative (and are not necessarily presented to a user in this arrangement) and may change in light of the various operations described herein.

An auction is selected (320). In certain implementations, the auction includes a first bid associated with a first advertisement and originating from a first advertiser, and a second bid associated with a second advertisement and originating from a second advertiser, though it should be understood that any number of additional bids can also be included in the auction. It should also be understood that in certain implementations, the first bid is greater than the second bid. For example, as shown in FIG. 4A and described at 310, an auction can be conducted with respect to a first bid (e.g., $0.50 per click) associated with a first advertisement (e.g., ‘Ad 1’ as shown in FIG. 4A) and originating from a first advertiser, and a second bid (e.g., $0.25 per click) associated with a second advertisement (e.g., ‘Ad 2’) and originating from a second advertiser.

It should also be noted that the auction can be selected from a plurality of auctions. That is, it should be understood that under most circumstances, advertising auctions can be conducted using known and/or conventional auction pricing methods, such as a generalized second-price (GSP) auction, as is known to those of ordinary skill in the art. Accordingly, the selection of a particular auction from among a number of auctions, as described herein, can be limited or constrained to remain within a selection threshold. That is, while most auctions are conducted using traditional or known methods (e.g., GSP auctions), a selection threshold can be defined (e.g., 2% of all auctions that are conducted), within which auctions can be selected in the manner described herein. In doing so, the bids that make up such selected auctions can be further processed, such as in the manner described herein.

At this juncture, it should be understood that while the vast majority of auctions are conducted conventionally (e.g., as GSP auctions), it can be advantageous, under certain circumstances, to conduct a small number of auctions (e.g., a number of auctions within the referenced selection threshold, such as 2% of all auctions) in a manner that enables the positions of various ads to be reassigned from the positions to which they were originally assigned. In doing so, possible outcomes to such positional reassignments of advertisements can be observed and analyzed. In part, observing and/or analyzing the outcomes of auctions where the positions of two (or more) advertisements are reassigned from their otherwise conventional positions can shed light on whether the positions dictated by such conventional positioning result in an optimal arrangement of advertisements, or whether alternate approaches may yield more optimal results.

For example, as described at 310 and illustrated in FIG. 4A, in a conventional auction an advertisement associated with a higher bid (e.g., ‘Ad 1,’ having a bid of $0.50 per click) can be assigned to a position that is more preferable than the position to which an advertisement with a lower bid (e.g., ‘Ad 2,’ having a bid of $0.25 per click) is assigned. However, it can be appreciated that in certain scenarios (such as where ‘Ad 2’ is a higher quality advertisement than ‘Ad 1’), assigning an advertisement having a lower bid (e.g., ‘Ad 2’ with a bid of $0.25 per click) to the more preferable position may actually yield more advertising revenue (over the same number of ad impressions) than the assignment of an advertisement having a higher bid (e.g., ‘Ad 1’) to the same position. For example, though an advertisement may only be associated with a bid that is 50% of the value (e.g., per click) of the bid of another advertisement, if the advertisement with the lower bid results in far more interest/interaction (e.g., clicks), such an advertisement can be considered more valuable, per ad impression, as the increased volume of interest/interaction can more than offset the discrepancy in bid amounts for each individual interaction. Moreover, an advertisement associated with a relatively higher bid (e.g., ‘Ad 1,’ having a bid of $0.50 per click) may not experience a significant (or any) decrease in traffic/interest if assigned to a lower position, and, if this is the case, the advertiser providing the relatively high bid for such an advertisement may be doing so sub-optimally (as the same or similar results may be achievable with a lower bid amount). Accordingly, it can be appreciated that such determinations (e.g., the optimal positional assignment of multiple advertisements that are participating in an advertising auction) can be identified/achieved by re-assigning the conventionally-assigned positions of one or more advertisements, and observing the outcome/performance of the advertisement(s) in such instances. Accordingly, described herein are various implementations that dictate the manner in which advertisements are re-assigned, as well as the manner in which the respective bids are accounted for when the assigned positions deviate from those dictated by conventional approaches.

One or more effective bids are computed (330). In certain implementations, such effective bids correspond to the product of an original bid (such as one of the bids referenced at 320) and a value selected at random from a set or range of values, such as the range [1, x]. Thus, continuing with the example referenced above and depicted in FIG. 4A, a first effective bid (associated with ‘Ad 1’) can be computed as the product of the original bid associated with the advertisement ($0.50 per click) and a first value (e.g., a value selected at random from the range [1, 10], such as 3), thereby resulting in a first effective bid of $1.50 (corresponding to $0.50×3). A second effective bid (associated with ‘Ad 2’) can be computed as the product of the original bid associated with the advertisement ($0.25 per click) and a second value (e.g., selected at random from the range [1, 10], such as 7), thereby resulting in a second effective bid of $1.75 (corresponding to $0.25×7).

Respective effective bids are compared (340). In doing so, a winning bid can be identified. Continuing the example referenced at 330, by comparing the effective bid associated with ‘Ad 1’ ($1.50) with the effective bid associated with ‘Ad 2’ ($1.75), the effective bid associated with ‘Ad 2’ can be identified as the winning bid.

One or more advertisers are charged (350). That is, based on the winning bid (such as the winning bid identified at 340), advertiser accounts 240 (such as those associated with the first advertiser and/or the second advertiser) can be charged a final auction price/respective final auction prices.

For example, in certain implementations, based on an identification of the second effective bid (that is, the effective bid associated with ‘Ad 2’) as the winning bid, the second advertiser can be charged a final auction price that corresponds to the first effective bid (that is, the effective bid associated with ‘Ad 1’) divided by the second value (that is, the value selected at random at 330 and used to compute the second effective bid), Continuing the example referenced at 340, upon identifying the effective bid associated with ‘Ad 2’ as the winning bid, a final auction price that corresponds to the effective bid computed with respect to ‘Ad 1’ (in this example, $1.50, as computed in the manner described above at 330) divided by the second value (in this example, 7, corresponding to the value selected at random and used in computing the second effective bid as described above at 330), thereby resulting in a final auction price of $0.21 per click (corresponding to $1.50/7).

In certain implementations, in such a scenario, the first advertiser (that is, the advertiser whose advertisement was not associated with the winning bid) can be charged a baseline price. Such a baseline price can reflect a reserve price or minimum bid amount for an advertising auction. For example, if the advertising auction (such as the auction selected at 320) has a reserve price or minimum bid amount of $0.10, the first advertiser can be charged this amount. In other implementations, such a baseline price can correspond to a bid from yet another advertiser, such as a bid amount that is less than both the first bid and the second bid. For example, it can be appreciated with reference to FIG. 4A that ‘Ad 3’ is associated with a bid amount ($0.15 per click) that is less than the first bid amount ($0.50) and the second bid amount ($0.25). Thus, in certain implementations the first advertiser can be charged a baseline price that reflects the bid amount ($0.15 per click) of such an advertiser.

Continuing with the present example, it can be appreciated that in certain scenarios, the effective bid of the first advertisement can be identified (such as at 340) as the winning bid, depending on the respective bid amounts and randomly selected values that make up the respective effective bids (as computed at 330). For example, in a scenario where the first effective bid (that is, the effective bid associated with ‘Ad 1’) corresponds to the product of an original bid of $0.50 per click and a randomly selected value of 3 (resulting in a first effective bid of $1.50), while the second effective bid corresponds to the product of an original bid of $0.25 per click and a randomly selected value of 4 (resulting in a second effective bid of $1.00), it can be appreciated that the first effective bid will be identified as the winning bid (such as at 340). In such implementations, based on an identification of the first effective bid as the winning bid, the first advertiser can be charged a final auction price that corresponds to the second effective bid (that is, the effective bid associated with ‘Ad 2’) divided by the first value (that is, the value selected at random and used to compute the first effective bid). Continuing the present example, upon identifying the effective bid associated with ‘Ad 1’ as the winning bid, a final auction price that corresponds to the effective bid computed with respect to ‘Ad 2’ (in this example, $1.00) divided by the first value (in this example, 3, corresponding to the value selected at random and used in computing the first effective bid as described above), thereby resulting in a final auction price of $0.33 per click (corresponding to $1.00/3). In such a scenario, the second advertiser can be charged a baseline price, such as a reserve price/minimum bid or a bid amount that is less than both the first bid and the second bid, substantially in the manner described above.

In other implementations, based on an identification of the first effective bid (that is, the effective bid associated with ‘Ad 1’) as the winning bid, the first advertiser can be charged an amount that corresponds to the second bid (that is, the original bid amount associated with ‘Ad 2,’ i.e., $0.25 per click). In such a scenario, the second advertiser can be charged the baseline price, substantially in the manner described above.

One or more advertisements are provided based on the winning bid (360). For example, in some implementations, having identified (such as at 340) the second effective bid (that is, the effective bid associated with ‘Ad 2’) as the winning bid, the associated advertisement (i.e., ‘Ad 2’) can be re-assigned to the first position, such as in the manner illustrated in FIG. 4B, which depicts the webpage of FIG. 4A after ‘Ad 1’ and ‘Ad 2’ have been re-assigned in the manner described herein. In such a scenario, the first advertisement (i.e., ‘Ad 1’) can be re-assigned to the second position, as is also illustrated in FIG. 4B. The respective ads can then be presented to a user at their respective re-assigned positions.

It should be understood that in certain implementations the second advertisement can be provided in lieu of the first advertisement. For example, in a scenario where only one ad slot is provided, upon identifying that the second effective bid as the winning bid, the second advertisement can be provided in lieu of the first advertisement.

Moreover, it should be noted that while much of the present disclosure has described scenarios that concern two advertisements (e.g., ‘Ad 1’ and ‘Ad 2’), this has been done only for the sake of simplicity and clarity. However, it should be understood that the various aspects and features described herein can be similarly implemented in settings that incorporate more than two advertisements. For example, effective bids can be computed for each of a number of bids in an auction, such as in the manner described at 330, a winning bid from among such effective bids can be identified, substantially in the manner described at 340, etc.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

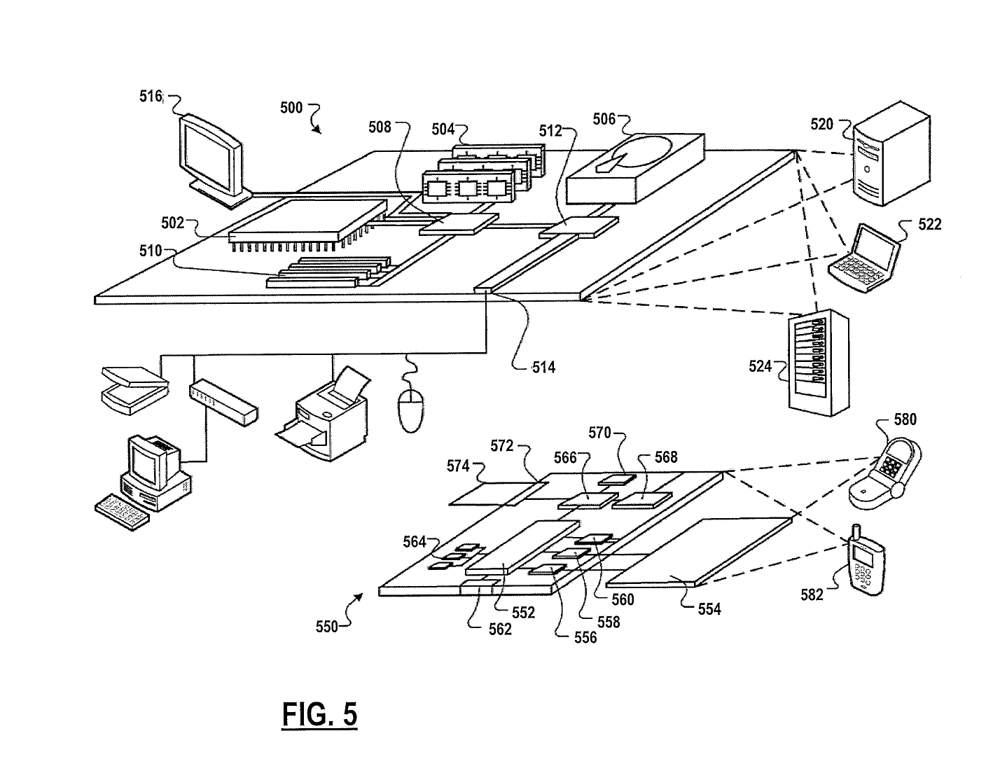

FIG. 5 shows an example of a computing device 500 and a mobile computing device that can be used to implement the techniques described herein the present specification. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 can also be another form of computer-readable medium, such as a magnetic or optical disk.

The storage device 506 is capable of providing mass storage for the computing device 500. In some implementations, the storage device 506 can be or contain a computer-readable medium, e.g., a computer-readable storage medium such as a floppy disk device, a hard disk device, an optical disk device, or a tape device, a flash memory or other similar solid state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which can accept various expansion cards (not shown). In the implementation, the low-speed interface 512 is coupled to the storage device 506 and the low-speed expansion port 514. The low-speed expansion port 514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 520, or multiple times in a group of such servers. In addition, it can be implemented in a personal computer such as a laptop computer 522. It can also be implemented as part of a rack server system 524. Alternatively, components from the computing device 500 can be combined with other components in a mobile device (not shown), such as a mobile computing device 550. Each of such devices can contain one or more of the computing device 500 and the mobile computing device 550, and an entire system can be made up of multiple computing devices communicating with each other.

The mobile computing device 550 includes a processor 552, a memory 564, an input/output device such as a display 554, a communication interface 566, and a transceiver 568, among other components. The mobile computing device 550 can also be provided with a storage device, such as a micro-drive or other device, to provide additional storage. Each of the processor 552, the memory 564, the display 554, the communication interface 566, and the transceiver 568, are interconnected using various buses, and several of the components can be mounted on a common motherboard or in other manners as appropriate.

The processor 552 can execute instructions within the mobile computing device 550, including instructions stored in the memory 564. The processor 552 can be implemented as a chipset of chips that include separate and multiple analog and digital processors. The processor 552 can provide, for example, for coordination of the other components of the mobile computing device 550, such as control of user interfaces, applications run by the mobile computing device 550, and wireless communication by the mobile computing device 550.

The processor 552 can communicate with a user through a control interface 558 and a display interface 556 coupled to the display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can provide communication with the processor 552, so as to enable near area communication of the mobile computing device 550 with other devices. The external interface 562 can provide, for example, for wired communication in some implementations, or for wireless communication in other implementations, and multiple interfaces can also be used.

The memory 564 stores information within the mobile computing device 550. The memory 564 can be implemented as one or more of a computer-readable medium or media, a volatile memory unit or units, or a non-volatile memory unit or units. An expansion memory 574 can also be provided and connected to the mobile computing device 550 through an expansion interface 572, which can include, for example, a SIMM (Single In Line Memory Module) card interface. The expansion memory 574 can provide extra storage space for the mobile computing device 550, or can also store applications or other information for the mobile computing device 550. Specifically, the expansion memory 574 can include instructions to carry out or supplement the processes described above, and can include secure information also. Thus, for example, the expansion memory 574 can be provide as a security module for the mobile computing device 550, and can be programmed with instructions that permit secure use of the mobile computing device 550. In addition, secure applications can be provided via the SIMM cards, along with additional information, such as placing identifying information on the SIMM card in a non-hackable manner

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 564, the expansion memory 574, or memory on the processor 552. In some implementations, the computer program product can be received in a propagated signal, for example, over the transceiver 568 or the external interface 562.

The mobile computing device 550 can communicate wirelessly through the communication interface 566, which can include digital signal processing circuitry where necessary. The communication interface 566 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 568 using a radio-frequency. In addition, short-range communication can occur, such as using a Bluetooth, WiFi, or other such transceiver (not shown). In addition, a GPS (Global Positioning System) receiver module 570 can provide additional navigation- and location-related wireless data to the mobile computing device 550, which can be used as appropriate by applications running on the mobile computing device 550.

The mobile computing device 550 can also communicate audibly using an audio codec 560, which can receive spoken information from a user and convert it to usable digital information. The audio codec 560 can likewise generate audible sound for a user, such as through a speaker, e.g., in a handset of the mobile computing device 550. Such sound can include sound from voice telephone calls, can include recorded sound (e.g., voice messages, music files, etc.) and can also include sound generated by applications operating on the mobile computing device 550.

The mobile computing device 550 can be implemented in a number of different forms, as shown in the figure. For example, it can be implemented as a cellular telephone 580. It can also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable storage medium and computer-readable storage medium refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A machine-readable storage medium does not include a machine-readable signal.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim clement having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for providing advertisements, the method comprising:
selecting, with a processor executing code, an auction, the auction comprising at least (a) a first bid from a first advertiser, the first bid being associated with a first advertisement, and (b) a second bid from a second advertiser, the second bid being associated with a second advertisement;
separately selecting each of a first value and a second value at random from a set or range of values;
computing (a) a first effective bid, the first effective bid comprising a product of the first bid and the first value and (b) a second effective bid, the second effective bid comprising a product of the second bid and the second value;
comparing the first effective bid and the second effective bid to identify a winning bid;
based on an identification of the second effective bid as the winning bid,
charging the second advertiser a final auction price comprising the first effective bid divided by the second value, and
charging the first advertiser a baseline price; and
providing, based on the winning bid, at least one of the first advertisement and the second advertisement.

2. The method of claim 1, further comprising: based on an identification of the first effective bid as the winning bid,
charging the first advertiser a final auction price comprising the second effective bid divided by the first value, and
charging the second advertiser the baseline price.

3. The method of claim 1, wherein the first bid is greater than the second bid.

4. The method of claim 3, further comprising: based on an identification of the first effective bid as the winning bid,
charging the first advertiser the second bid, and
charging the second advertiser the baseline price.

5. The method of claim 1, wherein selecting an auction comprises selecting an auction from a plurality of auctions.

6. The method of claim 5, wherein the auction is selected from the plurality of auctions within a selection threshold.

7. The method of claim 1, wherein the first value and the second value are selected from a set of values.

8. The method of claim 1, wherein the first value and the second value are selected at random from a set of values.

9. The method of claim 1, wherein the baseline price comprises a reserve price.

10. The method of claim 1, wherein the baseline price comprises a third bid from a third advertiser.

11. The method of claim 10, wherein the third bid is less than both the first bid and the second bid.

12. The method of claim 1, wherein providing at least one of the first advertisement and the second advertisement comprises providing the second advertisement in lieu of the first advertisement.

13. The method of claim 1, further comprising assigning the first advertisement to a first position and a second advertisement to a second position.

14. The method of claim 13, wherein providing at least one of the first advertisement and the second advertisement comprises: based on an identification of the second effective bid as the winning bid, re-assigning the first advertisement to the second position and the second advertisement to the first position.

15. A system comprising: one or more processors configured to interact with a computer-readable medium in order to perform operations comprising:
selecting an auction, the auction comprising at least (a) a first bid from a first advertiser, the first bid being associated with a first advertisement, and (b) a second bid from a second advertiser, the second bid being associated with a second advertisement;
separately selecting each of a first value and a second value at random from a set or range of values;
computing (a) a first effective bid, the first effective bid comprising a product of the first bid and the first value and (b) a second effective bid, the second effective bid comprising a product of the second bid and the second value;
comparing the first effective bid and the second effective bid to identify a winning bid;
based on an identification of the second effective bid as the winning bid,
charging the second advertiser a final auction price comprising the first effective bid divided by the second value, and
charging the first advertiser a baseline price; and
providing, based on the winning bid, at least one of the first advertisement and the second advertisement.

16. The system of claim 15, further configured to perform operations comprising: based on an identification of the first effective bid as the winning bid,
charging the first advertiser a final auction price comprising the second effective bid divided by the first value, and
charging the second advertiser the baseline price.

17. The system of claim 15, the first bid is greater than the second bid.

18. The system of claim 17, further configured to perform operations comprising: based on an identification of the first effective bid as the winning bid,
charging the first advertiser the second bid, and
charging the second advertiser the baseline price.

19. The system of claim 15, wherein selecting an auction comprises selecting an auction from a plurality of auctions.

20. The system of claim 19, wherein the auction is selected from the plurality of auctions within a selection threshold.

21. The system of claim 15, wherein the first value and the second value are selected from a set of values.

22. The system of claim 15, wherein the first value and the second value are selected at random from a set of values.

23. The system of claim 15, wherein the baseline price comprises a reserve price.

24. The system of claim 15, wherein the baseline price comprises a third bid from a third advertiser.

25. The system of claim 24, wherein the third bid is less than both the first bid and the second bid.

26. The system of claim 15, wherein providing at least one of the first advertisement and the second advertisement comprises providing the second advertisement in lieu of the first advertisement.

27. The system of claim 15, further configured to perform operations comprising assigning the first advertisement to a first position and a second advertisement to a second position.

28. The system of claim 27, wherein providing at least one of the first advertisement and the second advertisement comprises: based on an identification of the second effective bid as the winning bid, re-assigning the first advertisement to the second position and the second advertisement to the first position.

29. A non-transitory computer storage medium encoded with a computer program, the program comprising instructions that when executed by a data processing apparatus cause the data processing apparatus to perform operations comprising:
assigning a first advertisement to a first position and a second advertisement to a second position;
selecting an auction, the auction comprising at least (a) a first bid from a first advertiser, the first bid being associated with the first advertisement, and (b) a second bid from a second advertiser, the second bid being associated with the second advertisement;
computing (a) a first effective bid, the first effective bid comprising a product of the first bid and a first value and (b) a second effective bid, the second effective bid comprising a product of the second bid and a second value, each of the first value and the second value being separately selected at random from a set or range of values;
comparing the first effective bid and the second effective bid to identify a winning bid;
based on an identification of the second effective bid as the winning bid,
charging the second advertiser a final auction price comprising the first effective bid divided by the second value, and
charging the first advertiser a baseline price; and
reassigning, based on the winning bid, the first advertisement to the second position and the second advertisement to the first position.
